(19) United States
(12) Patent Application Publication
(10) Pub. No.: US 2025/0121275 A1
(43) Pub. Date: Apr. 17, 2025

(54) TRIVIA GAME WITH CONTEXTUAL GAMEPLAY AND METHOD OF PLAYING TRIVIA GAME WITH CONTEXTUAL GAMEPLAY

(71) Applicant: Drie Zussen Games, LLC, St. Louis, MO (US)

(72) Inventors: Ann Brinkerhoff, St. Louis, MO (US); Gretchen Stageberg, Denver, CO (US); Greta Eggers, St. Louis, MO (US)

(21) Appl. No.: 18/913,241

(22) Filed: Oct. 11, 2024

Related U.S. Application Data
(60) Provisional application No. 63/590,933, filed on Oct. 17, 2023.

(51) Int. Cl. A63F 9/18

(52) U.S. Cl. CPC A63F 9/18

(57) ABSTRACT

A trivia game including trivia cards and a multi-sided die. Each trivia card includes text representing card trivia question categories and contextually-linked trivia questions relating to the card trivia question categories. A side of the die includes text of a die trivia question category that corresponds to at least one card trivia question category. A turn of the trivia game includes a player rolling the die to land the die trivia question category, one trivia card being drawn, and an associated first question that has a card trivia question category that corresponds with the landed die trivia question category of the die being presented to the player for answering. If the associated first question is answered correctly, an associated second question is presented to the player for answering. The associated second question includes subject matter that is contextually related to subject matter of the associated first question.

### CROSS-REFERENCE TO RELATED APPLICATIONS

This application claims the benefit of priority of U.S. Provisional Application No. 63/590,933, filed Oct. 17, 2023, titled “TRIVIA GAME AND METHOD OF PLAYING TRIVIA GAME,” the contents and disclosures of which are hereby incorporated herein by reference in their entirety.

### TECHNICAL FIELD

The field of this disclosure relates generally to gameplay systems and methods for the playing of games including trivia games, card games, and/or board games. More specifically, the present disclosure pertains to games that combine chance and strategy, and, more particularly, to a trivia game that utilizes both cards and a die, and to a method of playing the game, as well as alternative embodiments of the same, including different game formats such as electronic games, interactive networks, and computer software.

### BACKGROUND

Trivia games are a type of game where players answer questions on various topics, for fun and/or to test their knowledge. These games can be played in different formats, such as board games, online games, or even live events. Some features of trivia games include: (i) categories (e.g., history, science, entertainment, geography, sports, etc.); (ii) questions (e.g., players are asked questions that they must answer correctly to earn points, where questions may range from easy to very difficult); (iii) scoring (e.g., points are awarded for correct answers, and the player or team with the most points at the end of the game wins); (iv) various formats (e.g., trivia games can be played individually or in teams, and can be structured in various ways, such as to include multiple-choice questions, true/false questions, and/or open-ended questions). Trivia games are often educational, fun, and can also be competitive. But trivia games may also present challenges for some players due to the difficulty of questions and the level of knowledge necessary for correctly answering the questions.

Playing card games, on the other hand, especially the well-known fifty-two deck face cards, offer the ability to play many different games, such as poker, blackjack, solitaire, but do not generally test knowledge outside of the game itself in the same manner that trivia games do. Many games played with the more common face cards are games of chance. In other words, these games have rules that require either the random selection of cards or depend on the occurrence of events outside the control of the players. Other games that require some strategy usually limit the level of strategy with restrictive rules of play.

Dice and various dice mechanics may be used in games such as board games. Such usage can vary widely, including adding elements of chance, strategy, and excitement. Some dice mechanics include: (i) roll and move, where players may roll dice to determine how many spaces they move in the game (e.g., players may roll two six-sided dice and move the total number of spaces as rolled); (ii) dice pool, where players may roll a set of dice and use the results to perform actions or resolve events in the game (e.g., players may roll five dice up to three times, with a goal of achieving a specific combination for points); and (iii) dice placement, where players may roll dice and then place them on the board to take actions and/or gain resources (e.g., players may roll dice and place them on action spaces to perform various tasks).

What is needed is a game that combines aspects of trivia games, card games, and dice games, in a manner that increases randomness and contextual linkages of questions, and has varying degrees of difficulty.

### BRIEF DESCRIPTION

In one aspect, a trivia game for one or more players includes a plurality of trivia cards and a die. Each trivia card of the plurality of trivia cards includes thereon (i) text representing a plurality of card trivia question categories, and (ii) text representing a plurality of contextually-linked trivia questions relating to the plurality of card trivia question categories. The plurality of contextually-linked trivia questions include a set of first questions including a first chance of answering any given first question of the set of first questions correctly, and a set of second questions including a second chance of answering any given second question of the set of second questions correctly, and the any given second question being contextually-linked to the any given first question. The die includes a plurality of sides, at least one side of the plurality of sides includes thereon text representing a die trivia question category that corresponds to at least one card trivia question category of the plurality of card trivia question categories. A turn of the trivia game includes: a player rolling the die to land the die trivia question category; one trivia card of the plurality of trivia cards being drawn for the player; an associated first question of the set of first questions of the one trivia card that has a card trivia question category that corresponds with the landed die trivia question category is presented to the player for answering; if the associated first question is answered correctly, an associated second question of the set of second questions of the one trivia card is presented to the player for answering, the associated second question including subject matter that is contextually related to subject matter of the associated first question; and if the associated second question is answered correctly, the player is awarded with a total amount of points corresponding to the correctly answered associated first question and the correctly answered associated second question.

In another aspect, a method of playing a trivia game for one or more players, including: providing a plurality of trivia cards, each trivia card of the plurality of trivia cards including thereon (i) text representing a plurality of card trivia question categories, and (ii) text representing a plurality of contextually-linked trivia questions relating to the plurality of card trivia question categories, the plurality of contextually-linked trivia questions including: a set of first questions including a first chance of answering any given first question of the set of first questions correctly; and a set of second questions including a second chance of answering any given second question of the set of second questions correctly, and the any given second question being contextually-linked to the any given first question. The method further includes providing a die including a plurality of sides, at least one side of the plurality of sides including thereon text of a die trivia question category that corresponds to at least one card trivia question category of the plurality of card trivia question categories. The method further includes playing a turn of the trivia game, including: rolling, by a player, the die to land the die trivia question category; drawing one trivia card of the plurality of trivia cards for the player; presenting an associated first question of the set of first questions of the one trivia card that has a card trivia question category that corresponds with the landed die trivia question category to the player for answering; if the associated first question is answered correctly, presenting an associated second question of the set of second questions of the one trivia card to the player for answering, the associated second question including subject matter that is contextually related to subject matter of the associated first question; and if the associated second question is answered correctly, awarding the player with a total amount of points corresponding to the correctly answered associated first question and the correctly answered associated second question.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements, which are presently discussed, it being understood, however, that the present embodiments are not limited to the precise arrangements and are instrumentalities shown, wherein:

FIG. 1 is an exemplary diagram of layout of a base question card according to one embodiment of the present disclosure.

FIG. 2 is an exemplary diagram of layout of a bonus question card according to one embodiment of the present disclosure.

FIG. 3 is an exemplary diagram of a category card according to one embodiment of the present disclosure.

FIG. 4 is an exemplary diagram of a base question card according to one embodiment of the present disclosure.

FIG. 5 is an exemplary diagram of a bonus question card according to one embodiment of the present disclosure.

FIGS. 6A, 6B, and 6C are exemplary diagrams of a die according to embodiments of the present disclosure.

FIG. 7 is a flowchart illustrating an exemplary method for playing according to one embodiment of the present disclosure.

FIGS. 8A and 8B are exemplary diagrams of playing environments according to embodiments of the present disclosure.

FIG. 9 is an exemplary diagram of personal computing devices according to one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Embodiments of the present disclosure are directed to a game of trivia and knowledge, including a novel method of game play and game components that in one embodiment are in the form of trivia cards and a die (however, the game components may take other forms, such as a board game, or the game may be played in different media, such as electronic games, video games, computer games, and interactive networks). In one embodiment, the game components include base question cards and corresponding bonus question cards each having trivia questions thereon, where the subject matter of the bonus question cards is contextually linked to that of the base question cards. A goal of the game is to score the highest number of points, for example by maximizing points by correctly answering both the trivia question on the base question card and the contextually-linked trivia question on the bonus question card. For example, in the event that the trivia question on the base question card is answered correctly but the contextually-linked trivia question on the bonus question card is not answered correctly, points would not be maximized as only one point may be awarded. The questions on the bonus question cards may generally be more-challenging and/or open-ended than the questions on the base question cards, and may test a deeper level of knowledge on the given topic. By presenting players with a two-stage question approach, for example a base (e.g., “first” or “initial”) question having only two possible answers (e.g., a 50/50 chance) and a bonus (e.g., “second” or “follow-up”) question being more challenging/open-ended, but still contextually related to the base question, the game is user-friendly to all types of players, while still providing increased levels of difficulty. A chance of answering the bonus (or second) question may vary depending on the knowledge of the player, but may generally be less than the 50/50 chance of answering the base (e.g., first) question correctly. The contextual relation of the bonus question to the base question represents a novel gameplay mechanic and results in varying levels of challenge. Categories on the die are also linked to those present on the various cards, such that the die both adds a degree of randomness (e.g., compared to just drawing cards) while also being linked to the cards.

During a session of gameplay, questions from the cards are presented to teams or individuals for answering, for the purpose of scoring points, for example. During a turn, a team or individual rolls the die (e.g., an eight-sided die) to determine a specific category from which questions are presented. For example, a side or face of the die corresponding to a category that may include “history” and may be facing upward after the die is rolled, and questions for that turn of the game may be asked from a card on which the category of “history” is printed. As such, there is a correlation between the category that lands via the die roll and the categories on the cards.

Two related questions may be presented to a team or individual during each turn of the game. The first question posed to the team or individual may be in the form of a multiple-choice question (e.g., a multiple-choice question with two possible response options). If the first question is answered correctly by the team or individual (e.g., if the correct response option is chosen or guessed by the team or individual), then a second question is posed to the same team or individual. The second question may require a factual response (e.g., is open-ended) and is related to the first question. In some embodiments, the first and second related questions and the corresponding correct responses are printed on opposite sides of a single card. In other embodiments, double-sided, tent-folded cards may be used. In some embodiments, a team or individual may receive one or more points for answering the first question correctly or for answering both the first and second questions correctly. In some embodiments, the game may be played in rounds, where each individual or team is provided one turn per round.

Each turn of the game may be a combination of the two questions that are related in some manner where the first question is presented in a format of a choice between two possible answers or responses (e.g., a multiple-choice question) so the responding team or individual has a fifty percent chance of guessing the right answer or response. If the first or initial question is answered correctly, the team or individual then has a chance of earning additional points (e.g., two or three or four additional points) by answering a second question (e.g., an open-ended question) that is related to the first question or that is related the response options presented with the first question. In some embodiments, one point is awarded to a team or individual if the team or individual answers the first question correctly. In some embodiments, two or three or four additional points are awarded to a team or individual if the team or individual answers the second question correctly (e.g., after answering the first question correctly). In some embodiments, the winning team or individual of the game is determined based on the team or individual that has the greatest number of points after a number of rounds (e.g., five rounds). In some embodiments, the winning team or individual of the game is determined based on the first team or individual to reach a target number of points (e.g., 21 points). Alternatively, a single player may play the game.

The game materials may include instructions on how to play the game, a plurality of cards (e.g., question cards) on which one or more questions are provided (e.g., printed), and a die (e.g., an eight-sided die, a six-sided die, or a die with more or less sides, or more than one die). A category (e.g., math, science, history, music, etc.) may also be provided (e.g., printed) on each card that corresponds to the questions that are printed on the card. Text of categories may be provided and visible on (e.g., printed on or engraved in) different sides or faces of the die, such category text corresponding to one or more categories that are printed on the cards. In some embodiments, the categories may be grouped into topics, which may include: (i) Animal Vegetable Mineral (e.g., abbreviated as “AVM” or “AVM”); (ii) Creative Expressions (e.g., abbreviated as “CEXP” or “CEXP”); (iii) Just For Fun (e.g., abbreviated as “JFF” or “JFF”); (iv) Science & Technology (e.g., abbreviated as “S&T” or “S&T”); and/or (v) Who When Where (e.g., abbreviated as “WWW” or “WWW”). While superscript styling is shown as being used on certain letters of the category text in one embodiment, other embodiments may use alternate text styling, and the use of superscript is not limiting. The AVM category may include questions directed to animals, vegetables, minerals, food, plants, and/or drinks, for example. The CEXP category may include questions directed to art, literature, entertainment, music, movies, and TV, for example. The JFF category may include questions directed to sports, leisure, games, and just for fun, for example. The S&T category may include questions directed to all sciences, technology, inventions, and anatomy, for example. The WWW category may include questions directed to people and events, history, and geography, for example. A separate category card listing such categories and their respective coverage topics may be provided as part of the game materials.

In some embodiments, and, for example, because of the format of the base questions (e.g., first questions), each team or individual is given at least a fifty percent chance of answering the first question of their turn correctly (e.g., each team or individual has at least a fifty percent chance of receiving at least one point during their turn) regardless of the level of knowledge or skill of the team or individual. Rather than open-ended questions, which are generally more difficult to answer, the first (or initial) question may be presented in the form of a multiple-choice question.

In some embodiments, there may be “lose turn” side or face on the die used to play the game. In some embodiments, when the “lose turn” section or side of the die is displayed after rolling the die, the team or individual who rolled the die will not be presented with a question, will lose their turn, and will not be presented with any points. In some embodiments, when a team or individual loses their turn, the game proceeds to a turn for the next team or individual. The “lose turn” side or face of the die helps to limit the possibility of one team or individual outscoring the other teams or individuals by a wide margin. The “lose turn” option may be labeled as “LOOZ TURN” on the die. In some embodiments, there may be a “rival choose” side or face on the die used to play the game. This option permits the other team(s) to choose the category of the base question to be asked of the team who rolled the die. In such a scenario, if the base question is answered correctly, the bonus question that follows may be in that same category that the other team(s) chose. The “rival choose” option may be labeled as “RIVAL CHOOZ” on the die. The use of the letter “z” in place of certain occurrences of the letter “s” may be done to conform to and/or emphasize a naming scheme and/or other branding of the game.

In some embodiments, the game may include a pre-determined amount of question cards containing a pre-determined amount of questions (e.g., 150 question cards with 1,500 questions (e.g., 5 base questions on one side of a card and 5 bonus questions on the other side of the same card)); a pre-determined amount of category cards (e.g., two); a pre-determined amount of dice (e.g., one die, such as one eight-sided die); a pre-determined amount of score pads (e.g., two score pads); a pre-determined amount of writing instruments for recording scores (e.g., two pencils); and/or a timing device (e.g., a one-minute sand timer). However, this is not limiting and other configurations of the materials of the game may be implemented. As described herein, an object of the game is to be the individual or team to score the highest number of points.

Pre-game procedures may include the following. Forming two or more teams of players, which may include two teams of three or four players, although individual players may also compete against each other rather than forming teams. Each team may choose a team captain. Team captains may be the only team member permitted to announce final answers decided by the team for each question. Players may agree on the duration of the game based on either: (i) a predetermined amount of points (e.g., 50 points) being scored, where the game ends when one team or player reaches the designated points threshold, and that team (or player) is declared the winner, or (ii) a predetermined amount of time (e.g., 30 or 45 minutes), where the game ends when that amount of time has elapsed, and the team (or player) with the highest number of points when time expires is declared the winner. Each team captain may roll the die. In some embodiments, the team rolling the initial, capital letter shown on the die that is closest to the beginning of the alphabet (e.g., A, C, J, L, R, S or W) may win control of the die, and may roll first to begin the game, where A, C, J, L, R, S or W correspond to the first letters of text provided on the sides or faces of the die. In the event of a tie, the teams may roll again.

Play and scoring procedures may include the following. The team controlling the die may roll to determine the category (e.g., AVM, CEXP, JFF, S&T, WWW) of the first base question to be read by anyone who is not on that team. Base questions are also referred to herein as “OR” questions, which relates to the base questions being in a 50/50 (e.g., either/or) format. The base question cards may be labeled as “OR” cards. Questions from the side of the card (e.g., the side labeled “OR”) are intended to be asked first after the die is rolled. The “OR” label may be provided within or associated with a graphic such as a shaded/colored box or other shape or graphic on the cards.

If a loose turn (e.g., “LOOZ TURN”) side of the die is rolled, the team that rolled such side may lose control of the die, and the die may be passed to the next team to roll for a new base question (e.g., a new “OR” question).

If a “rival choose” (e.g., “RIVAL CHOOZ”) side of the die is rolled, the other team(s) may choose the category of the base question (e.g., the “OR” question) to be asked of the team who rolled the die. For example, if the base question is answered correctly, the bonus question that follows may be in that same category that the other team(s) chose.

If the base question (e.g., the “OR” question) is NOT answered correctly, the team may lose control of the die, and the die may be passed to the next team to roll for a new base question (e.g., a new “OR” question). If the base question (e.g., the “OR” question) is answered correctly, the team scores a pre-determined amount of points (e.g., one point), and is then asked the corresponding contextually-linked bonus question in the same category, which may appear on the opposite side of the same card.

Bonus point procedures may include the following. Bonus questions may be indicated by a designated symbol, such as main symbol of the game provided adjacent (e.g., under) a category label of the bonus question, and may include one or more parts (e.g., a two-part question), which may be worth a pre-determined amount of points (e.g., two or four points) if answered correctly. For example, two-part bonus questions may include words that are visually distinguishable from other text on the card by visual emphasis such as bold and underlined text, and the words may include words such as: “EITHER . . . OR”; “TWO of THREE”; and the like, as described herein (see Examples A and B below). The bonus associated with a two-part bonus question may be referred to an elevated bonus. For example, if only one part of a two-part question is answered correctly, the team may score two points but lose control of the die, and the die may be passed to the next team to roll for a new base question (e.g., a new “OR” question). If both parts are answered correctly, the team may score four points, keep control of the die, and roll again for a new base question (e.g., a new “OR” question). If neither part of the question is answered correctly, the team may lose control of the die, and the die may be passed to the next team to roll for a new base question (e.g., a new “OR” question). In some embodiments, any points awarded by correctly answering a bonus question may be added to a team's cumulative, overall total and are not counted or recorded separately.

If there is not a main symbol adjacent indicating bonus points under the category label of the bonus point question, the bonus question may be a one-part question (e.g., instead of a two-part question), and may be worth only two points if answered correctly (see Example C below). If the team answers the question correctly, the team may score two points, keep control of the die, and roll again for a new base question (e.g., a new “OR” question). If the question is not answered correctly, the team may lose control of the die, and the die may be passed to the next team to roll for a new base question (e.g., a new “OR” question). In some embodiments, any points awarded by correctly answering a bonus question may be added to a team's cumulative, overall total and are not counted or recorded separately.

Example questions are shown via the samples provided below in Examples A, B, and C.

Example A:

Question: CEXP-Name the character in “Movie A” who EITHER longed for a heart OR was a good witch.

Answer: [Character 1; Character 2]

In Example A, the team must correctly answer both parts of the two-part question (“Character 1” and “Character 2”) to receive maximum points (e.g., four points), and to retain control of the die. However, if the team correctly answers only one part of the two-part question (e.g., “Character 1” or “Character 2”) they may score fewer points (e.g., two points) than when answering both correctly, and may lose control of the die.

Example B:

Question: JFF—Name THREE of the FOUR original characters in the 1980's arcade version of “Video Game”.

Answer: [Character 1; Character 2; Character 3; Character 4]

In Example B, the team must provide four of the four character names (e.g., all four of Character 1; Character 2; Character 3; and Character 4) to receive maximum points (e.g., four points), and to retain control of the die. However, if the team provides only three names (e.g., three names, such as Character 1/Character 2/Character 3; Character 1/Character 2/Character 4; etc.) they may score less than maximum points (e.g., two points) and may lose control of the die. In Example B, points may be awarded as follows: (i) if three characters are correctly provided, the team is awarded two points but loses control of the die; (ii) if four characters are correctly provided, the team is awarded four points and keeps control of the die; and (iii) if no characters, one character or two characters are provided, no additional points are awarded and the team loses control of the die.

In some embodiments, a two-part question such as in Example B requires the team to provide a complete answer, which in the case of Example B may include naming at least three of four characters. Such a question could alternatively require all four characters to be named, as described. In cases where three of four or four of four items are required to completely answer the question, identifying only one or two of the items may not be accepted as a correct or partial answer in some embodiments, and the team would not receive any bonus points, and they would lose control of the die (but will still have been awarded the corresponding point for correctly answering the associated base question).

Example C:

Question: WWW-Name the only Great Lake that does NOT border the state of Michigan.

Answer: [Lake Ontario]

In Example C, there may not be a main symbol adjacent (e.g., under) the category label of the bonus point question, indicating that the bonus question is a one-part question, and is worth a lesser amount of points (e.g., two points) compared, for example, to a two-part bonus question, if answered correctly. If the question is answered correctly, the team may score two points, keep control of the die, and roll again for a new base question (e.g., a new “OR” question). If the question is not answered correctly, the team may lose control of the die, and the die may be passed to the next team.

There may be variations of play. Additional variations of play may include a “Just Once” variation, a “Bonus Pass” variation, and/or a “Bonus Optional” variation, for example. The “Just Once” variation includes teams taking turns rolling the die just once per round, regardless of whether or not the bonus points question is answered correctly. Points here may be scored in the same manner as in standard play. The “Bonus Pass” variation includes if the team controlling the die answers the base question (e.g., “OR” question) correctly, the bonus question is read, however, before that team discusses their answer, they may elect to pass that bonus question to a different team, such as the next team. If the team to whom the bonus question is passed is unable to answer any part of that bonus question, the team who originally passed that question retains control of the die without having to answer that bonus question, and rolls for a new base question (e.g., a new “OR” question). If the team to whom the bonus question is passed is able to answer any part of the question correctly, then that team receives the appropriate points and takes control of the die to roll for their new base question (e.g., new “OR” question). In the “Bonus Optional” variation, teams can elect to not attempt the bonus points question after correctly answering the base question (e.g., the “OR” question) without losing control of the die. However, the team must decide whether or not to attempt to answer the bonus points question before it is read.

Additional rules and other gameplay aspects may include the following. Each team may have a certain time duration (e.g., up to one minute) to discuss the question and/or answer(s). Team captains may provide the team's final answer(s). Mobile electronic devices such as smartphones and tablets, including apps, may not be allowed to help answer questions. Unless otherwise noted, “currently”, “modern-day”, and/or similar terms may refer to a certain year (e.g., ˜2022) when playing with the question cards, but this is able to be updated over time such as via the issuance of updated packs of cards that may encompass more recent events. Audible comments from rival players may help opponents answer related bonus point questions and score more points. The choices presented in the base questions (e.g., the “OR” questions) may be listed in alphabetical or ascending order (“yes or no” and “male or female” being exceptions), meaning there is no pattern as to how often the first choice is the correct answer. Spelling and grammatical liberties used on packaging, on cards, etc. of the game may be taken in support of adhering to a name or other spelling theme of the game (e.g., the letter “s” at the end of a word may be replaced with a “z” such that terms such as “points” may instead be “pointz”).

The size and font type of any text on any instructions, cards, and/or die may be selected from any plurality of sizes and fonts. The orientation and positioning of any text on any instructions, cards, and/or die may be selected from any plurality of respective orientations and locations. Branding (e.g., including logos, slogans, etc.) may appear on any packaging and/or instructions, cards, and/or die. This may include licensed branding (e.g., branding of other entities).

A related website may be maintained for sale of the game and/or to contact the distributor of the game, for example to address consumer questions and/or concerns such as if it is believed that an answer to one of the questions is incorrect, and/or to provide other feedback. The game and/or additional cards (e.g., such as updated card packs) may be obtained from retail outlets, for example.

As described herein, conventional trivia games lack randomness, contextual linkage between questions, and may be too difficult to appeal to a wide variety of players of various ages and knowledge.

The problems addressed herein include: (i) inability for known games to contextually link a second type of question to a first type of question; (ii) inability for known games to link a die to question cards based on a common element such as a common category; (iii) limited degrees of randomness that may be used to play the game; and/or (iv) limited appeal to a wide variety of players.

The resulting effect and/or benefits achieved herein include at least one of: (i) ability to contextually link a second type of question to a first type of question; (ii) ability to link a die to question cards based on a common element such as a common category; (iii) increased degrees of randomness that may be used to play the game; (iv) wide appeal to and playability by a wide variety of players; and/or (v) providing additional information and gameplay features to a player of the game within a limited amount of display space provided on the die and/or on the cards, including additional information to the player during gameplay to apprise the player of the status of triggering bonus points.

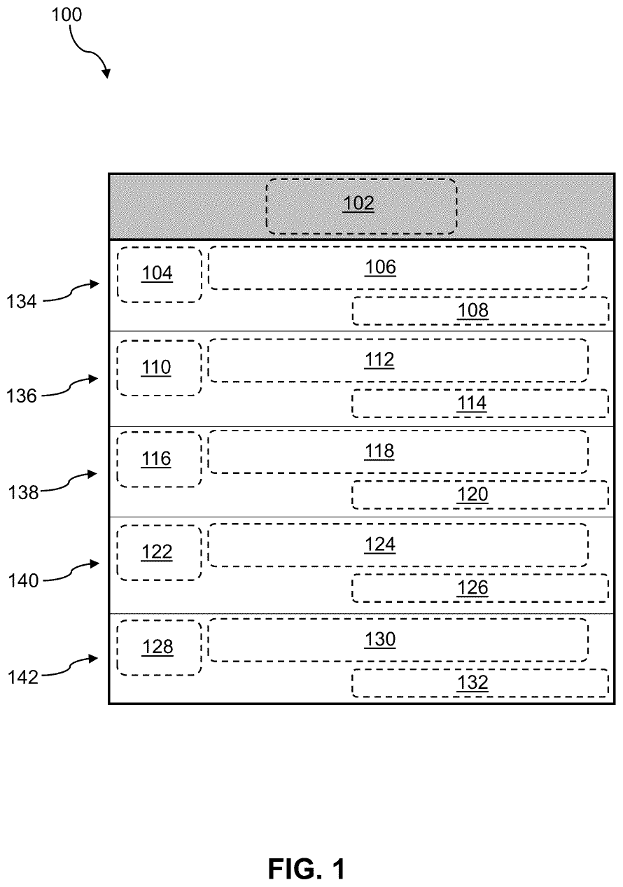

FIG. 1 illustrates an exemplary embodiment of a layout 100 of a base question interface, which may be embodied on a physical card (e.g., a paper/cardboard card with printed designs and/or text thereon). Title block 102 illustrates a portion of layout 100 in which title text of layout 100 may be provided. The title in title block 102 may indicate which type of layout that layout 100 represents (such as a layout of a base question, also referred to as an “OR” question), as described herein. A plurality of category blocks, question blocks, and answer blocks may be provided within layout 100. In one embodiment, five category blocks, five question blocks, and five answer blocks are provided within layout 100, as shown in FIG. 1.

Category block 104 illustrates a portion of layout 100 in which category text may be provided. The category text may indicate a category of the game, as described herein. Question block 106 illustrates a portion of layout 100 in which question text may be provided. The question in question block 106 is related to the category in category block 104, as described herein. Answer block 108 illustrates a portion of layout 100 in which answer text may be provided. The answer in answer block 108 is an answer to the question in question block 106, as described herein. In some embodiments, someone other than a team member of the team attempting to answer the question may read the question(s) and/or answer(s).

Category block 110 illustrates a portion of layout 100 in which category text of a second category may be provided, where the category text in category block 110 may indicate a category of the game different than that in category block 104 (and/or any other category blocks of layout 100), as described herein. Question block 112 illustrates a portion of layout 100 in which question text of a question relating to the category in category block 110 may be provided, as described herein. Answer block 114 illustrates a portion of layout 100 in which answer text of an answer to the question in question block 112 may be provided, as described herein.

Category block 116 illustrates a portion of layout 100 in which category text of a third category may be provided, where the category text in category block 116 may indicate a category of the game different than that in category blocks 104 and 110 (and/or any other category blocks of layout 100), as described herein. Question block 118 illustrates a portion of layout 100 in which question text of a question relating to the category in category block 116 may be provided, as described herein. Answer block 120 illustrates a portion of layout 100 in which answer text of an answer to the question in question block 118 may be provided, as described herein.

Category block 122 illustrates a portion of layout 100 in which category text of a fourth category may be provided, where the category text in category block 122 may indicate a category of the game different than that in category blocks 104, 110, and 116 (and/or any other category blocks of layout 100), as described herein. Question block 124 illustrates a portion of layout 100 in which question text of a question relating to the category in category block 122 may be provided, as described herein. Answer block 126 illustrates a portion of layout 100 in which answer text of an answer to the question in question block 124 may be provided, as described herein.

Category block 128 illustrates a portion of layout 100 in which category text of a fifth category may be provided, where the category text in category block 128 may indicate a category of the game different than that in category blocks 104, 110, 116, and 122 (and/or any other category blocks of layout 100), as described herein. Question block 130 illustrates a portion of layout 100 in which question text of a question relating to the category in category block 128 may be provided, as described herein. Answer block 132 illustrates a portion of layout 100 in which answer text of an answer to the question in question block 130 may be provided, as described herein.

Section 134 of layout 100 indicates a section relating to category block 104, question block 106, and answer block 108, all of which are related to one another, as described herein. Section 136 of layout 100 indicates a section relating to category block 110, question block 112, and answer block 114, all of which are related to one another, as described herein. Section 138 of layout 100 indicates a section relating to category block 116, question block 118, and answer block 120, all of which are related to one another, as described herein. Section 140 of layout 100 indicates a section relating to category block 122, question block 124, and answer block 126, all of which are related to one another, as described herein. Section 142 of layout 100 indicates a section relating to category block 128, question block 130, and answer block 132, all of which are related to one another, as described herein.

In one embodiment, each of category blocks 104, 110, 116, 122, and 128 are directed to different categories. In other embodiments, a portion of these blocks may be directed to the same category or categories different than Animal Vegetable Material (e.g., “AVM”), Creative Expressions (e.g., “CEXP”), Just For Fun (e.g., “JFF”), Science & Technology (e.g., “S&T”), and/or Who When Where (e.g., “WWW”). The amount of category blocks, question blocks, and answer blocks is not limited to that shown in and described in connection with FIG. 1, and more or less blocks may be implemented in layout 100.

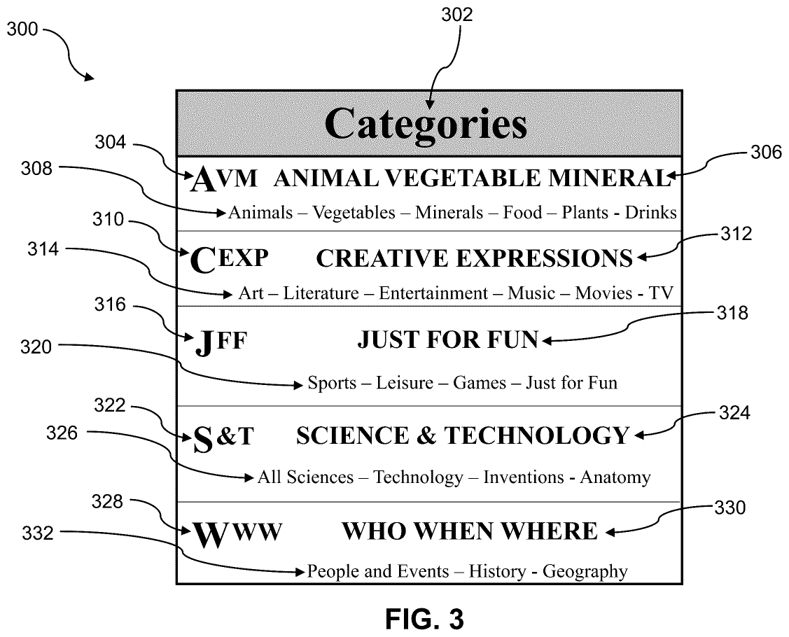

A format the same as or similar to layout 100 may also be used in connection with a category card (shown in FIG. 3). The category card may be included with the game as part of the instruction materials, helping explain the various categories of the game to players. One or more copies of such a category card may be included with the game materials.

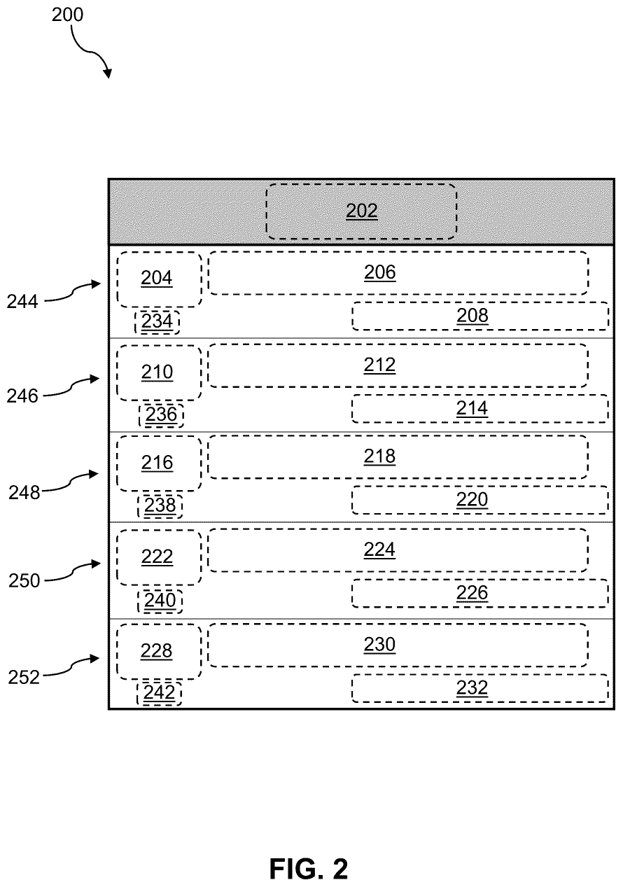

FIG. 2 illustrates an exemplary embodiment of a layout 200 of a bonus question interface, which may be embodied on a physical card (e.g., a paper/cardboard card with printed designs and/or text thereon). Title block 202 illustrates a portion of layout 200 in which title text of layout 200 may be provided. The title in title block 202 may indicate which type of layout that layout 200 represents (such as a layout of a bonus question), as described herein. A plurality of category blocks, question blocks, and answer blocks may be provided within layout 200. In one embodiment, five category blocks, five question blocks, and five answer blocks are provided within layout 200, as shown in FIG. 2. These blocks may include text that is contextually related to the text in the corresponding blocks shown in FIG. 1, as described herein.

Category block 204 illustrates a portion of layout 200 in which category text may be provided. The category text may indicate a category of the game, as described herein. Question block 206 illustrates a portion of layout 200 in which question text may be provided. The question in question block 206 is related to the category in category block 204, as described herein. Answer block 208 illustrates a portion of layout 200 in which answer text may be provided. The answer in answer block 208 is an answer to the question in question block 206, as described herein. The category in category block 204 may be the same as that in category block 104 of layout 100, and the question in question block 206 may be contextually related to the question in question block 106 of layout 100, as described herein.

Category block 210 illustrates a portion of layout 200 in which category text of a second category may be provided, where the category text in category block 210 may indicate a category of the game different than that in category block 204 (and/or any other category blocks of layout 200), as described herein. Question block 212 illustrates a portion of layout 200 in which question text of a question relating to the category in category block 210 may be provided, as described herein. Answer block 214 illustrates a portion of layout 200 in which answer text of an answer to the question in question block 212 may be provided, as described herein. The category in category block 210 may be the same as that in category block 110 of layout 100, and the question in question block 212 may be contextually related to the question in question block 112 of layout 100, as described herein.

Category block 216 illustrates a portion of layout 200 in which category text of a third category may be provided, where the category text in category block 216 may indicate a category of the game different than that in category blocks 204 and 210 (and/or any other category blocks of layout 200), as described herein. Question block 218 illustrates a portion of layout 200 in which question text of a question relating to the category in category block 216 may be provided, as described herein. Answer block 220 illustrates a portion of layout 200 in which answer text of an answer to the question in question block 218 may be provided, as described herein. The category in category block 216 may be the same as that in category block 116 of layout 100, and the question in question block 218 may be contextually related to the question in question block 118 of layout 100, as described herein.

Category block 222 illustrates a portion of layout 200 in which category text of a fourth category may be provided, where the category text in category block 222 may indicate a category of the game different than that in category blocks 204, 210, and 216 (and/or any other category blocks of layout 200), as described herein. Question block 224 illustrates a portion of layout 200 in which question text of a question relating to the category in category block 222 may be provided, as described herein. Answer block 226 illustrates a portion of layout 200 in which answer text of an answer to the question in question block 224 may be provided, as described herein. The category in category block 222 may be the same as that in category block 122 of layout 100, and the question in question block 224 may be contextually related to the question in question block 124 of layout 100, as described herein.

Category block 228 illustrates a portion of layout 200 in which category text of a fifth category may be provided, where the category text in category block 228 may indicate a category of the game different than that in category blocks 204, 210, 216, and 222 (and/or any other category blocks of layout 200), as described herein. Question block 230 illustrates a portion of layout 200 in which question text of a question relating to the category in category block 228 may be provided, as described herein. Answer block 232 illustrates a portion of layout 200 in which answer text of an answer to the question in question block 230 may be provided, as described herein. The category in category block 228 may be the same as that in category block 128 of layout 100, and the question in question block 230 may be contextually related to the question in question block 130 of layout 100, as described herein.

Layout 200 may include, for each question in question blocks 206, 212, 218, 224, and 230, a respective indicator 234, 236, 238, 240, and 242, which indicates if any particular question qualifies for an elevated amount of bonus points (e.g., four points instead of two points), as described herein. While each question block 206, 212, 218, 224, and 230 is shown in FIG. 2 as having a corresponding indicator 234, 236, 238, 240, and 242, it is not the case that every question associated with question blocks 206, 212, 218, 224, and 230 will always have an elevated bonus associated therewith. In some embodiments, only certain designated questions may have an associated elevated bonus. Indicators 234, 236, 238, 240, and 242 as shown in FIG. 2 function to indicate that any one question may have an elevated bonus associated therewith, not that every question always has an associated elevated bonus (although on any given card, each question may indeed have an associated elevated bonus). For example, in an embodiment that includes five questions, the available elevated bonuses may range from zero to five, where no questions may have an elevated bonus, all five questions may have an elevated bonus, or any number therebetween may have an elevated bonus.

Section 244 of layout 200 indicates a section relating to category block 204, question block 206, answer block 208, and/or indicator 234, all of which are related to one another, as described herein. Section 246 of layout 200 indicates a section relating to category block 210, question block 212, answer block 214, and/or indicator 236, all of which are related to one another, as described herein. Section 248 of layout 200 indicates a section relating to category block 216, question block 218, answer block 220, and/or indicator 238, all of which are related to one another, as described herein. Section 250 of layout 200 indicates a section relating to category block 222, question block 224, answer block 226, and/or indicator 240, all of which are related to one another, as described herein. Section 252 of layout 200 indicates a section relating to category block 228, question block 230, answer block 232, and/or indicator 242, all of which are related to one another, as described herein.

In one embodiment, each of category blocks 204, 210, 216, 222, and 228 may be directed to different categories, although such different categories will still match the categories in corresponding category blocks 104, 110, 116, 122, and 128 of layout 100, as described herein. In other embodiments, a portion of these blocks may be directed to the same category or categories different than Animal Vegetable Material (e.g., “AVM”), Creative Expressions (e.g., “CEXP”), Just For Fun (e.g., “JFF”), Science & Technology (e.g., “S&T”), and/or Who When Where (e.g., “WWW”), in correspondence with the categories of layout 100. The amount of category blocks, question blocks, and answer blocks is not limited to that shown in and described in connection with FIG. 2, and more or less blocks may be implemented in layout 200, in correspondence with the amount of blocks in layout 100.

In one embodiment, layout 100 and layout 200 may be provided on a same card, with layout 100 being provided on one side of the card and layout 200 being provided on an opposite side of the same card. Such a configuration may assist with the contextual relationship of the questions of layout 200 with the questions of layout 100. For example, if a player correctly answers a question of layout 100, the card may be flipped over so that the corresponding question of layout 200 may be presented to the player. In other embodiments, layout 100 and layout 200 may be provided on separate cards, or the card may be of a different form factor. For example, a card on which layouts 100 and 200 are provided may be a card with a fold delineating portions of the card, and layout 100 may be provided on one side of a fold and layout 200 on the other side of the fold. In general, layout 100 should be provided on a side or portion of a card that is opposite from layout 200, so that the questions associated with each are able to be kept apart from one another, while still being on a same card. A card is but one form factor that may be used for the game, and other physical formats including but not limited to sheets of paper may be used for providing layouts 100 and 200 thereon (e.g., paper pad with sheets with layouts 100 and 200 printed thereon, such as on opposite sides of the same sheet). In digital embodiments (described herein), layouts 100 and 200 may be presented as a visual graphic, which may be a digital representation of a physical playing card.

FIG. 3 illustrates an exemplary embodiment of a category card 300. Category card 300 may include thereon a plurality of categories, including a description of each category, a symbol of each category, and example topics associated with each category. Category card 300 may include a layout similar to layout 100 shown in FIG. 1 (see like reference characters in FIG. 1).

Title text 302 may include a title. In the embodiment shown in FIG. 3, title text 302 may include “Categories,” indicating the type of card as a category card. Category text 304 may include a shortened version of the category, such as a symbol or an abbreviation of the category. In the embodiment shown in FIG. 3, category text 304 may include “AVM,” indicating the AVM category as described herein. Expanded category text 306 may include text that spells out or further explains category text 304. In the embodiment shown in FIG. 3, expanded category text 306 may include “ANIMAL VEGETABLE MINERAL” in association with the AVM category of category text 304. Topics text 308 may include text that outlines topics within the category. In the embodiment shown in FIG. 3, topics text 308 may include “Animals—Vegetables—Minerals—Food—Plants—Drinks” in association with category text 304 and expanded category text 306.

Category text 310 may include a shortened version of the category, such as a symbol or an abbreviation of the category. In the embodiment shown in FIG. 3, category text 310 may include “CEXP,” indicating the CEXP category as described herein. Expanded category text 312 may include text that spells out or further explains category text 310. In the embodiment shown in FIG. 3, expanded category text 312 may include “CREATIVE EXPRESSIONS” in association with the CEXP category of category text 310. Topics text 314 may include text that outlines topics within the category. In the embodiment shown in FIG. 3, topics text 314 may include “Art—Literature—Entertainment—Music—Movies—TV” in association with category text 310 and expanded category text 312.

Category text 316 may include a shortened version of the category, such as a symbol or an abbreviation of the category. In the embodiment shown in FIG. 3, category text 316 may include “JFF,” indicating the JFF category as described herein. Expanded category text 318 may include text that spells out or further explains category text 316. In the embodiment shown in FIG. 3, expanded category text 318 may include “JUST FOR FUN” in association with the JFF category of category text 316. Topics text 320 may include text that outlines topics within the category. In the embodiment shown in FIG. 3, topics text 320 may include “Sports—Leisure—Games—Just for Fun” in association with text category 316 and expanded category text 318.

Category text 322 may include a shortened version of the category, such as a symbol or an abbreviation of the category. In the embodiment shown in FIG. 3, category text 322 may include “S&T,” indicating the S&T category as described herein. Expanded category text 324 may include text that spells out or further explains category text 322. In the embodiment shown in FIG. 3, expanded category text 324 may include “SCIENCE & TECHNOLOGY” in association with the S&T category of category text 322. Topics text 326 may include text that outlines topics within the category. In the embodiment shown in FIG. 3, topics text 326 may include “All Sciences—Technology—Inventions—Anatomy” in association with category text 322 and expanded category text 324.

Category text 328 may include a shortened version of the category, such as a symbol or an abbreviation of the category. In the embodiment shown in FIG. 3, category text 328 may include “WWW,” indicating the WWW category as described herein. Expanded category text 330 may include text that spells out or further explains category text 328. In the embodiment shown in FIG. 3, expanded category text 330 may include “WHO WHEN WHERE” in association with the WWW category of category text 328. Topics text 332 may include text that outlines topics within the category. In the embodiment shown in FIG. 3, topics text 332 may include “People and Events—History—Geography” in association with category text 328 and expanded category text 330.

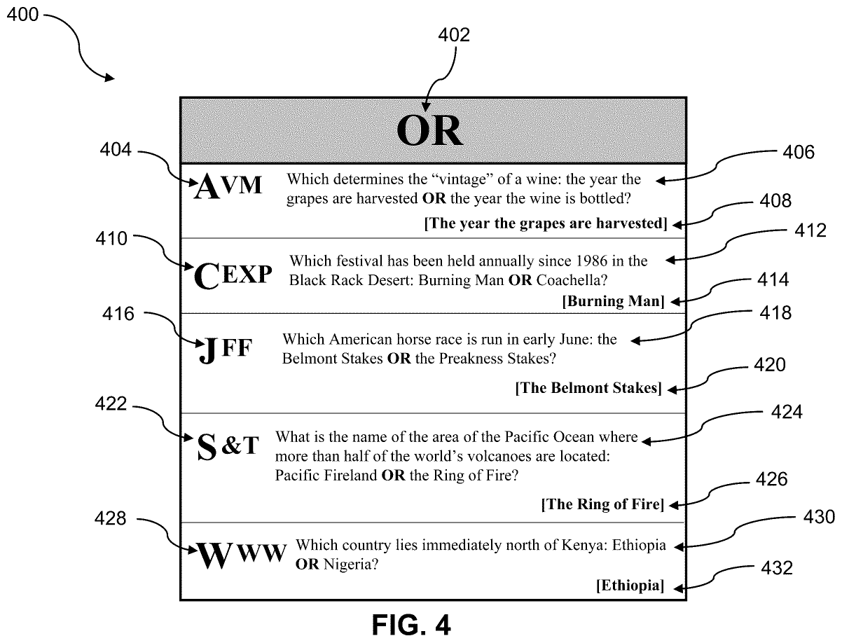

FIG. 4 illustrates an exemplary embodiment of a base question card 400. Base question card 400 may include thereon a plurality of categories, and a plurality of questions and corresponding answers associated with each category. Base question card 400 may include a layout the same as or similar to layout 100 shown in FIG. 1 (see like reference characters in FIG. 1).

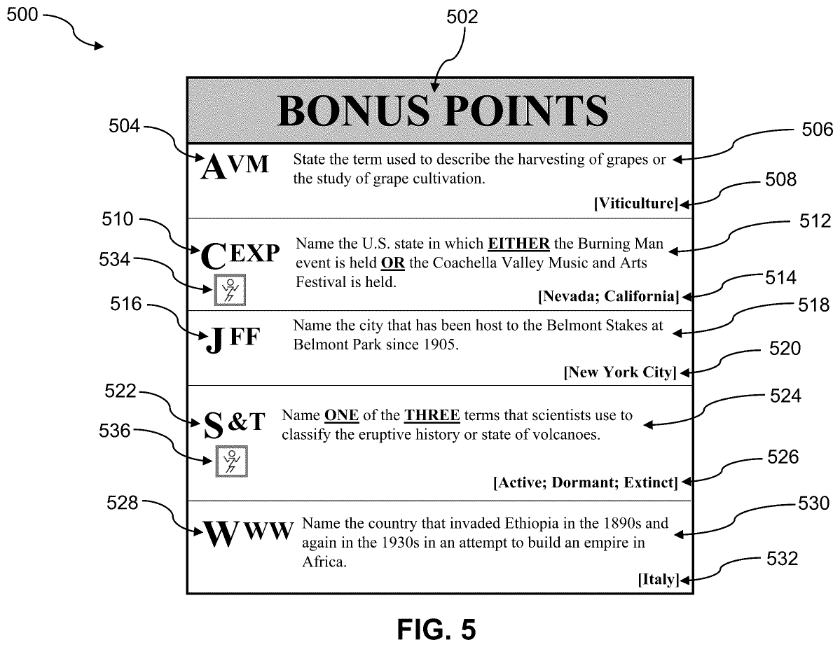

Title text 402 may include a title. In the embodiment shown in FIG. 4, title text 402 may include “OR,” indicating the type of card as a base question card (also referred to herein as an “OR” card). Category text 404 may include a shortened version of the category, such as a symbol or an abbreviation of the category. In the embodiment shown in FIG. 4, category text 404 may include “AVM,” indicating the AVM category as described herein. Question text 406 may include text of a question relating to the category of category text 404. In the embodiment shown in FIG. 4, question text 406 may include “Which determines the “vintage” of a wine: the year the grapes are harvested OR the year the wine is bottled?” in association with the AVM category of category text 404. Answer text 408 may include text that answers the question of question text 406. In the embodiment shown in FIG. 4, answer text 408 may include “[The year the grapes are harvested]” in association with category text 404. Selective highlighting of text, including bolding and underlining, and/or other punctuation may be used to emphasize certain words or portions in question text 406 and answer text 408. For example, with reference to FIG. 4, the word “OR” in question text 406 may be in bold, and the entire answer in answer text 408 may be in bold and also bounded by brackets (and likewise for the other question text and answer text shown in FIG. 4 (and in FIG. 5), as applicable).

Category text 410 may include a shortened version of the category, such as a symbol or an abbreviation of the category. In the embodiment shown in FIG. 4, category text 410 may include “CEXP,” indicating the CEXP category as described herein. Question text 412 may include text of a question relating to the category of category text 410. In the embodiment shown in FIG. 4, question text 412 may include “Which festival has been held annually since 1986 in the Black Rack Desert: Burning Man OR Coachella?” in association with the CEXP category of category text 410. Answer text 414 may include text that answers the question of question text 412. In the embodiment shown in FIG. 4, answer text 414 may include “[Burning Man]” in association with category text 410.

Category text 416 may include a shortened version of the category, such as a symbol or an abbreviation of the category. In the embodiment shown in FIG. 4, category text 416 may include “JFF,” indicating the JFF category as described herein. Question text 418 may include text of a question relating to the category of category text 416. In the embodiment shown in FIG. 4, question text 418 may include “Which American horse race is run in early June: the Belmont Stakes OR the Preakness Stakes?” in association with the JFF category of category text 416. Answer text 420 may include text that answers the question of question text 418. In the embodiment shown in FIG. 4, answer text 420 may include “[The Belmont Stakes]” in association with category text 416.

Category text 422 may include a shortened version of the category, such as a symbol or an abbreviation of the category. In the embodiment shown in FIG. 4, category text 422 may include “S&T,” indicating the S&T category as described herein. Question text 424 may include text of a question relating to the category of category text 422. In the embodiment shown in FIG. 4, question text 424 may include “What is the name of the area of the Pacific Ocean where more than half of the world's volcanoes are located: Pacific Fireland OR the Ring of Fire?” in association with the S&T category of category text 422. Answer text 426 may include text that answers the question of question text 424. In the embodiment shown in FIG. 4, answer text 426 may include “[The Ring of Fire]” in association with category text 422.

Category text 428 may include a shortened version of the category, such as a symbol or an abbreviation of the category. In the embodiment shown in FIG. 4, category text 428 may include “WWW,” indicating the WWW category as described herein. Question text 430 may include text of a question relating to the category of category text 428. In the embodiment shown in FIG. 4, question text 430 may include “Which country lies immediately north of Kenya: Ethiopia OR Nigeria?” in association with the WWW category of category text 428. Answer text 432 may include text that answers the question of question text 430. In the embodiment shown in FIG. 4, answer text 432 may include “[Ethiopia]” in association with category text 428.

FIG. 5 illustrates an exemplary embodiment of a bonus question card 500. Bonus question card 500 may include thereon a plurality of categories, and a plurality of questions and corresponding answers associated with each category, in correspondence with the questions on base question card 400 shown in FIG. 4. Bonus question card 500 may include a layout the same as or similar to layout 200 shown in FIG. 2 (see like reference characters in FIG. 2).

Title text 502 may include a title. In the embodiment shown in FIG. 5, title text 502 may include “BONUS POINTS,” indicating the type of card as a bonus question card. Category text 504 may include a shortened version of the category, such as a symbol or an abbreviation of the category. In the embodiment shown in FIG. 5, category text 504 may include “AVM,” indicating the AVM category as described herein, and matching category text 404 of base question card 400 shown in FIG. 4. Question text 506 may include text of a question relating to the category of category text 504, and that is also contextually related to the category of category text 404 and/or the question of question text 406. In the embodiment shown in FIG. 5, question text 506 may include “State the term used to describe the harvesting of grapes or the study of grape cultivation.” in association with the AVM category of category text 504, and also contextually related to the category of category text 404 and/or the question of question text 406. For example, when comparing question text 406 that includes the question “Which determines the “vintage” of a wine: the year the grapes are harvested OR the year the wine is bottled?” as shown in FIG. 4 with question text 506 that includes the question “State the term used to describe the harvesting of grapes or the study of grape cultivation.”, the contextual link between the question of question text 406 and the question of question text 506 is shown to be grapes and/or wine subject matter. If a player gets the question of question text 406 correct, they may then get a chance to get additional points by correctly answering the question of question text 506. Answer text 508 may include text that answers the question of question text 506. In the embodiment shown in FIG. 5, answer text 508 may include “[Viticulture]” in association with category text 504. Selective highlighting of text, including bolding and underlining, and/or other punctuation may be used to emphasize certain words or portions in question text 506 and answer text 508. For example, with reference to FIG. 5, the entire answer in answer text 508 may be in bold and also bounded by brackets (and likewise for the other question text and answer text shown in FIG. 5, as applicable). As described herein, terms such as “BONUS POINTS” may instead be “BONUS POINTZ” and/or include other wording to match a name and/or branding of the game.

Category text 510 may include a shortened version of the category, such as a symbol or an abbreviation of the category. In the embodiment shown in FIG. 5, category text 510 may include “CEXP,” indicating the CEXP category as described herein. Question text 512 may include text of a question relating to the category of category text 510. In the embodiment shown in FIG. 5, question text 512 may include “Name the U.S. state in which EITHER the Burning Man event is held OR the Coachella Valley Music and Arts Festival is held.” in association with the CEXP category of category text 510. When comparing question text 412 that includes the question “Which festival has been held annually since 1986 in the Black Rack Desert: Burning Man OR Coachella?” as shown in FIG. 4 with question text 512 that includes the question “Name the U.S. state in which EITHER the Burning Man event is held OR the Coachella Valley Music and Arts Festival is held.”, the contextual link between the question of question text 412 and the question of question text 512 is shown to be the festival subject matter (e.g., Burning Man or Coachella). If a player gets the question of question text 412 correct, they may then get a chance to get additional points by correctly answering the question of question text 512. Answer text 514 may include text that answers the question of question text 512. In the embodiment shown in FIG. 5, answer text 514 may include “[Nevada; California]” which, by way of the semi-colon, answers the EITHER/OR type question of question text 512. With reference to FIG. 5, the words “EITHER” and “OR” in question text 512 may be in bold, as described herein.

Category text 516 may include a shortened version of the category, such as a symbol or an abbreviation of the category. In the embodiment shown in FIG. 5, category text 516 may include “JFF,” indicating the JFF category as described herein. Question text 518 may include text of a question relating to the category of category text 516. In the embodiment shown in FIG. 5, question text 518 may include “Name the city that has been host to the Belmont Stakes at Belmont Park since 1905.” in association with the JFF category of category text 516. When comparing question text 418 that includes the question “Which American horse race is run in early June: the Belmont Stakes OR the Preakness Stakes?” as shown in FIG. 4 with question text 518 that includes the question “Name the city that has been host to the Belmont Stakes at Belmont Park since 1905.”, the contextual link between the question of question text 418 and the question of question text 518 is shown to be the horse race subject matter (e.g., Belmont Stakes). If a player gets the question of question text 418 correct, they may then get a chance to get additional points by correctly answering the question of question text 518. Answer text 520 may include text that answers the question of question text 518. In the embodiment shown in FIG. 5, answer text 520 may include “[New York City]” in association with question text 518.

Category text 522 may include a shortened version of the category, such as a symbol or an abbreviation of the category. In the embodiment shown in FIG. 5, category text 522 may include “S&T,” indicating the S&T category as described herein. Question text 524 may include text of a question relating to the category of category text 522. In the embodiment shown in FIG. 5, question text 524 may include “Name ONE of the THREE terms that scientists use to classify the eruptive history or state of volcanoes” in association with the S&T category of category text 522. When comparing question text 424 that includes the question “What is the name of the area of the Pacific Ocean where more than half of the world's volcanoes are located: Pacific Fireland OR the Ring of Fire?” as shown in FIG. 4 with question text 524 that includes the question “Name ONE of the THREE terms that scientists use to classify the eruptive history or state of volcanoes”, the contextual link between the question of question text 424 and the question of question text 524 is shown to be the volcanoes subject matter. If a player gets the question of question text 424 correct, they may then get a chance to get additional points by correctly answering the question of question text 524. Answer text 526 may include text that answers the question of question text 524. In the embodiment shown in FIG. 5, answer text 526 may include “[Active; Dormant; Extinct]” in association with category text 522. The semi-colons present in answer text 526 correspond to the answer being an answer to a “ONE of the THREE” type question of question text 524. With reference to FIG. 5, the words “ONE” and “THREE” in question text 524 may be in bold and/or underline, as described herein.

Category text 528 may include a shortened version of the category, such as a symbol or an abbreviation of the category. In the embodiment shown in FIG. 5, category text 528 may include “WWW,” indicating the WWW category as described herein. Question text 530 may include text of a question relating to the category of category text 528. In the embodiment shown in FIG. 5, question text 530 may include “Name the country that invaded Ethiopia in the 1890s and again in the 1930s in an attempt to build an empire in Africa.” in association with the WWW category of category text 528. When comparing question text 430 that includes the question “Which country lies immediately north of Kenya: Ethiopia OR Nigeria?” as shown in FIG. 4 with question text 530 that includes the question “Name the country that invaded Ethiopia in the 1890s and again in the 1930s in an attempt to build an empire in Africa.”, the contextual link between the question of question text 430 and the question of question text 530 is shown to be the country subject matter (e.g., Ethiopia). If a player gets the question of question text 430 correct, they may then get a chance to get additional points by correctly answering the question of question text 530. Answer text 532 may include text that answers the question of question text 530. In the embodiment shown in FIG. 5, answer text 532 may include “[Italy]” in association with category text 528.

Indicators 534 and 536 are an implementation of indicators 234-242 shown in FIG. 2. Indicators 534 and 536 may include a “bonus symbol” to indicate to players that the question associated with indicator 534 may be worth elevated bonus points if answered correctly, as described herein. The bonus symbol may be a symbol that relates to a design aspect of the game, such as a logo associated with the game. In the embodiment shown in FIG. 5, the question of question text 512 and 524 are indicated via indicators 534 and 536, respectively, as being worth elevated bonus points if answered correctly. While question texts 506, 518, and 530 are not shown in FIG. 5 as having corresponding indicators such as indicators 534 and 536, indicators such as indicators 534 and 536 may be applied to each of question texts 506, 518, and 530 in the manner shown by indicators 234, 236, 238, 240, and 242 and as described herein (e.g., in connection with FIG. 2) if such question were two-part questions.

FIG. 4 may be viewed in relation to FIG. 1, where FIG. 4 is one implementation of an embodiment of layout 100. FIG. 5 may be viewed in relation to FIG. 2, where FIG. 5 is one implementation of an embodiment of layout 200. Title text 302 as shown in FIG. 3, title text 402 as shown in FIG. 4, and title text 502 as shown in FIG. 5 are examples of title phrasing and are not limiting. Other titles may be implemented. Layout 100 shown in FIG. 1, layout 200 shown in FIG. 2, and the layouts of card 300 shown in FIG. 3, card 400 shown in FIG. 4, and card 500 shown in FIG. 5 are examples of layouts and are not limiting. The titles, categories, questions, answers, and/or (e.g., bonus) indicators may be laid out in other orientations in other implementations. For example, layouts may be in portrait or landscape views, and the organization of questions, answers, and indicators may be varied. Questions 406, 412, 418, 424, and 430 may be referred to as a set of first questions, and questions 506, 512, 518, 524, and 530 may be referred to as a set of second questions, with individual questions within the sets being contextually-linked via common subject matter according to the following question pairs: 406/506, 412/512, 418/518, 424/524, and 430/530. Each first question 406, 412, 418, 424, and 430 of the set of first questions is associated with a first chance of answering any given first question of the set of first questions correctly, namely a 50/50 chance as described herein. Each second question 506, 512, 518, 524, and 530 of the set of second questions is associated with a second chance of answering any given second question of the set of second questions correctly. In most cases the first and second chances of correctly answering will not be the same, as the second questions do not have the 50/50 multiple choice format as do the first questions, and as such do not represent a clear-cut fifty percent chance of correctly answering the question as do the first questions. Moreover, correctly answering the second questions relies more heavily on the knowledge level of any given player more so than the first questions do.

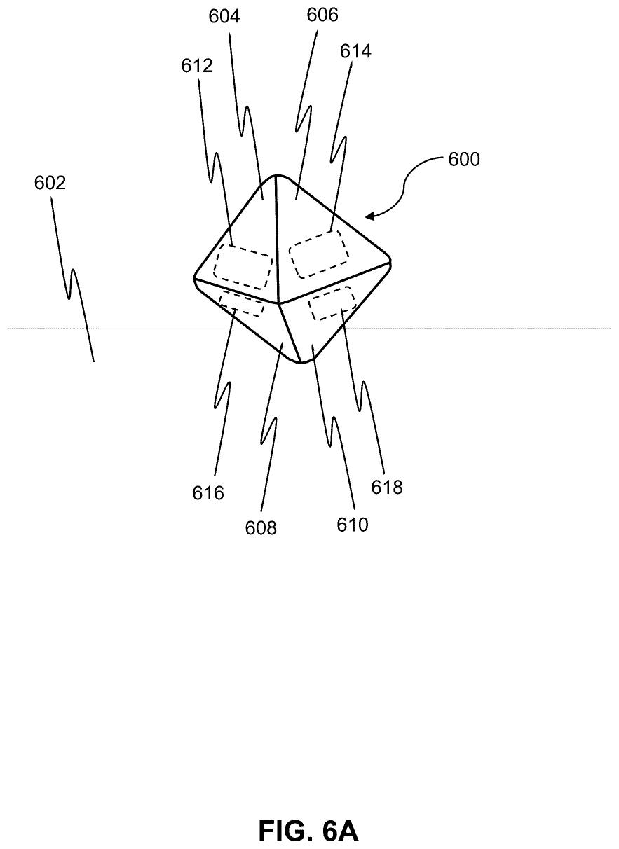

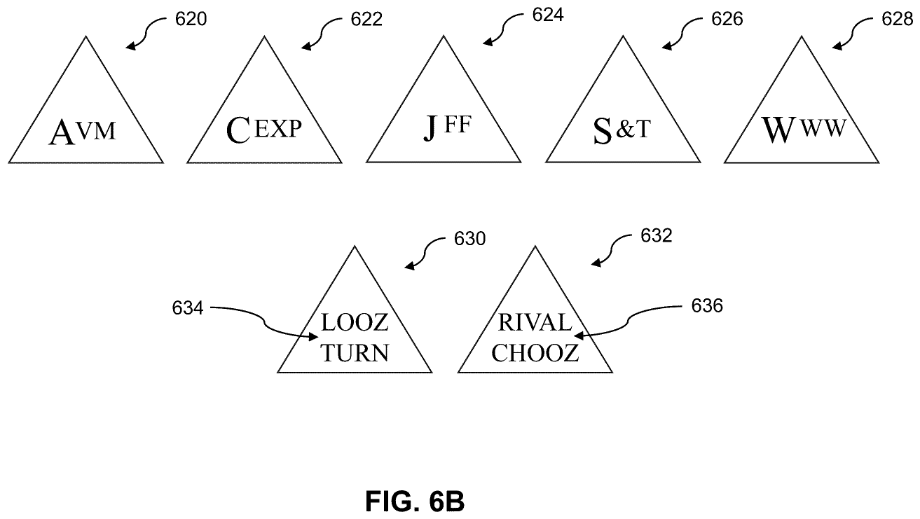

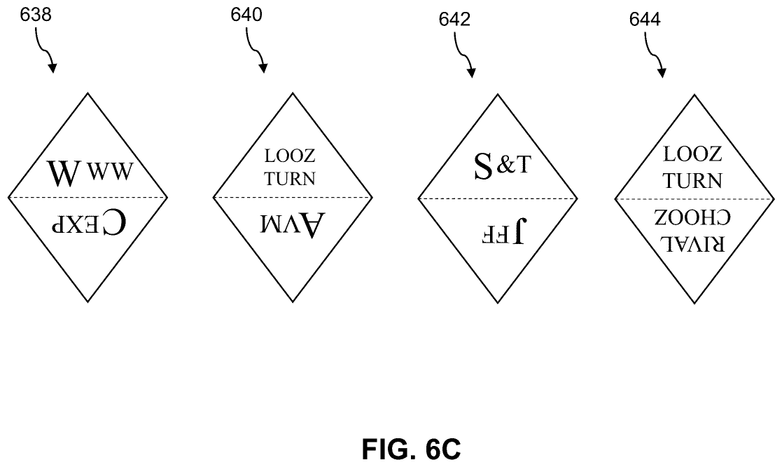

FIGS. 6A, 6B, and 6C illustrate exemplary embodiments of a die 600 provided with and for use in playing of the game. In the embodiment shown in FIG. 6A, die 600 is an eight-sided die for rolling on a playing surface 602. FIG. 6A only shows four sides 604, 606, 608, and 610 of die 600 (the four other sides are not visible/shown). Sides of die 600 may also be referred to as faces, or a face may be a sub-part of a side. Each side of die 600 may have provided thereon text such as category text 304/404/504, 310/410/510, 316/416/516, 322/422/522, and 328/428/528 shown in FIGS. 3/4/5, respectively. Portion 612 of side 604, portion 614 of side 606, portion 616 of side 608, and portion 618 of side 610 are portions in which such category text may be provided, such as by printing, engraving, or similar techniques. The other four sides that are not shown have portions the same as or similar to portions 612, 614, 616, and 618. The rolling of die 600 will land a certain side of die 600 displaying certain category text of a category, and the player will then need to answer a question from the same category on a card such as card(s) 400 and/or 500.

FIG. 6B illustrates an embodiment of the types of category text that can be provided on various faces of die 600. For example, the category symbols shown in FIG. 6B may correspond to the categories shown on cards 300/400/500, and more specifically to category text 304/404/504, 310/410/510, 316/416/516, 322/422/522, and 328/428/528 as shown in FIGS. 3/4/5. Face 620 may include category text “AVM”, face 622 may include category text “CEXP”, face 624 may include category text “JFF”, face 626 may include category text “S&T”, and face 628 may include category text “WWW”. Faces 630 and 632 may include text relating to player/team turns. Face 630 may include lose turn text 634 such as “LOOZ TURN”, and face 632 may include rival choose text 636 such as “RIVAL CHOOZ”. Each side of die 600 may be formed with a face such as faces 620, 622, 624, 626, 628, 630, and 632 as described in more detail in connection with FIG. 6C. The particular choice of category text shown on faces 620-632 in FIG. 6B is only one implementation, and is not limiting.

FIG. 6C illustrates embodiments of text pairings for adjacent side/face pairs that may be implemented on die 600. With reference to FIG. 6A, adjacent side/face pairs include sides 604/608 and sides 606/610. There would also be two other side/face pairs for the sides of die 600 not visible in FIG. 6A. FIG. 6C illustrates adjacent side/face pair 638 which may include “WWW”/“CEXP”, adjacent side/face pair 640 which may include “LOOZ TURN”/“AVM”, adjacent side/face pair 642 which may include “S&T”/“JFF”, and adjacent side/face pair 644 which may include “LOOZ TURN”/“RIVAL CHOOZ”. With reference to FIG. 6A, the category text shown in FIG. 6C would be placed within portions 612/616 and 614/618 (and likewise for the sides of die 600 not visible in FIG. 6A), as described herein. The particular choice of category pairings such as shown on faces 620-632 in FIG. 6B is only one implementation, and is not limiting. Certain categories or other gameplay aspects such as “LOOZ TURN” and/or “RIVAL CHOOZ” may appear twice or more on any one die (e.g., two faces may include “LOOZ TURN”).

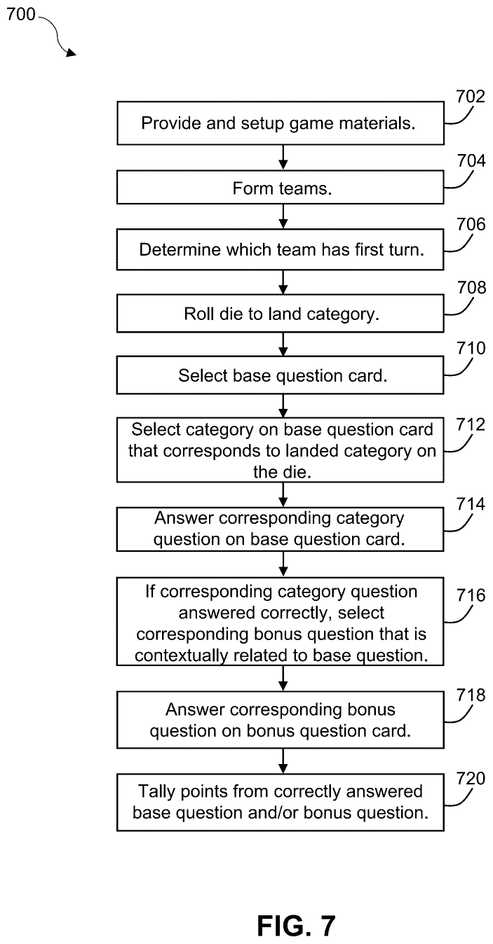

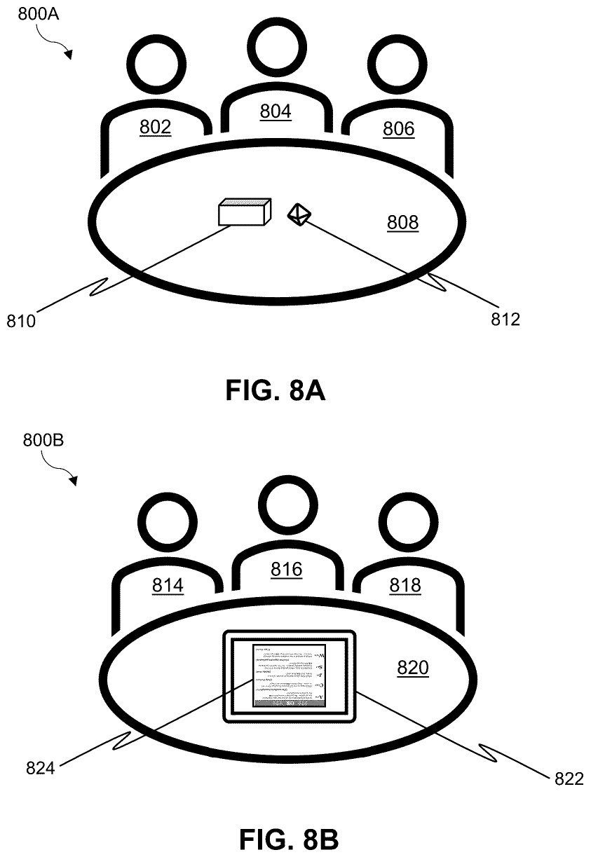

FIG. 7 illustrates an example method 700 for playing the game. Method 700 includes providing/setting up 702 game materials, forming 704 teams, and determining 706 which team has the first turn. This may include, for example, each team rolling the die, and the team rolling the initial, capital letter (e.g., corresponding to the categories and/or other text present on faces of the die) that is closest to the beginning of the alphabet (e.g., A, C, J, L, R, S or W) may win control of the die, and may roll first to begin the game (where in the event of a tie, the teams may roll again), as described herein. Method 700 further includes rolling 708 the die to land a category, selecting 710 a base question card, and selecting 712 a category on the base question card that matches the landed category on the die. For example, if the AVM face (e.g., 620 shown in FIG. 6B) of a die (e.g., 600 shown in FIG. 6A) lands, a card is drawn (e.g., from cards 810 shown in FIG. 8A) and an AVM base question (e.g., base question 406) is presented. Method 700 further includes answering 714 the corresponding category question on the base question card, and, if the corresponding category question is answered correctly, selecting 716 a corresponding bonus question (e.g., bonus question 506) that is contextually related to base question. Method 700 further includes answering 718 the corresponding bonus question on the bonus question card, and tallying 720 any points from correctly answering the base question and/or the bonus question, as described herein. If the bonus question includes a bonus symbol (e.g., 534, 536 shown in FIG. 5), extra points may be awarded. Method 700 represents one non-limiting embodiment of gameplay, and gameplay may be varied as described herein (e.g., regarding duration, point thresholds, etc.)

It is also contemplated that the game described herein can be implemented on existing and readily available electronic devices, such as computers, video games, electronic games, and/or on interactive networks utilizing computer software and text, including mobile applications downloadable from mobile application platforms, or “live” sessions of the games hosted on servers and the like for remote play via the internet. Such electronic devices can visually display the cards and enable the players to execute turns as described herein. Commercially available electronic communication devices can also be provided to enable players to communicate with each other over long distances.

FIGS. 8A and 8B illustrate embodiments of playing of the game via a plurality of players. FIG. 8A illustrates an embodiment of a playing environment 800A, including a plurality of players 802, 804, and 806, a playing surface 808, a plurality of cards 810 of the game (e.g., where cards 810, and cards 400 and 500, may be referred to as trivia cards), and a die 812 of the game. Plurality of cards 810 may include cards that are the same as or similar to cards 300, 400, and 500 as shown in FIGS. 3, 4, and 5, respectively. In some embodiments, plurality of cards 810 may include (i) 150 double-sided cards where one side of a card presents base questions such as shown in connection with base question card 400, and the other side of the same card presents bonus questions such as shown in connection with bonus question card 500, and (ii) two category cards such as category cards 300, explaining the categories. Die 812 may be the same as or similar to die 600 as shown in and described in connection with FIGS. 6A-6C. Players 802, 804, and 806 may play each other individually. Additionally, there may be more (or less) players than players 802, 804, and 806 as shown in FIG. 8A, and the players may form themselves into opposing teams as described herein.

FIG. 8B illustrates an embodiment of a playing environment 800B, including a plurality of players 814, 816, and 818, a playing surface 820, a personal computing device 822 such as a tablet, and game application 824 provided on personal computer device 822 for execution by and display on personal computing device 822. Game application 824 may be a computer program (e.g., code) providing a digital embodiment of the physical embodiment of the game as shown FIG. 8A, and may be programmed to include digital versions of a plurality of cards that are the same as or similar to plurality of cards 810 as shown in FIG. 8A and/or a digital version of a die that is the same as or similar to die 600/812 as shown in FIGS. 6A-6C and 8A, respectively. Players 814, 816, and 818 may play each other individually, or form as opposing teams with other players. To simulate the real-world randomness of the drawing of a random card and/or the rolling of a physical die, game application 824 may be programmed with a random number generator that may be utilized for one or both of the rolling of the digital die and the selection of the digital cards. Additionally, there may be more (or less) players than players 814, 816, and 818 as shown in FIG. 8B, and the players may form themselves into opposing teams as described herein. Yet further, there may be more than one personal computing device 822, and the plurality of personal computing devices 822 may be capable of interfacing with one another to allow community play of game application 824, such as via the internet, and as described herein, in a manner that simulates physical (e.g., in-person) gameplay such as shown in environment 800A.

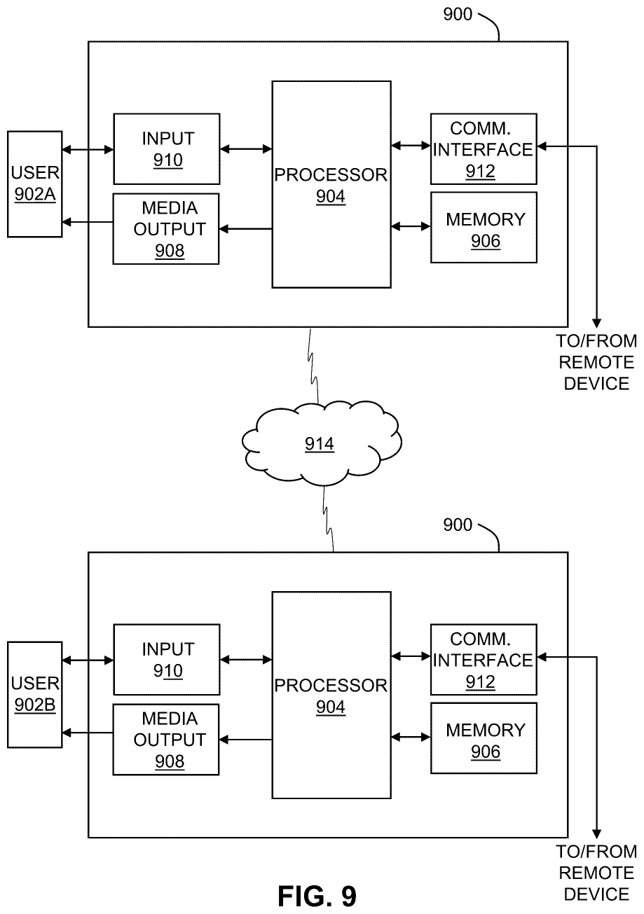

FIG. 9 illustrates an example configuration 900 of a personal computing device the same as or similar to personal computing 822 as shown in FIG. 8B that may be used by players to play a digital version of the game (e.g., game application 824 as shown in FIG. 8B) as described herein. For example, the gameplay aspects described herein may be implemented in a video game emulating the physical game, and the video game may be played by one or more users 902A, 902B (e.g., players), each having a respective personal computing device configured according to configuration 900. Each personal computing device according to configuration 900 may include a processor 904 operatively coupled with a memory 906, and may include at least one media output component 908 for presenting information to respective users 902A, 902B. In some embodiments, media output component 908 includes an output adapter such as a video adapter and/or an audio adapter. An output adapter is operatively coupled to processor 904 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones). In some embodiments, each personal computing device configured according to configuration 900 may include an input device 910 for receiving input from respective users 902A, 902B. Input device 910 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 908 and input device 910. Each personal computing device configured according to configuration 900 may further include a communication interface 912 so that each personal computing device may communicate with other computing devices (e.g., remote devices) such as servers and the like. Any plurality of personal computing device configured according to configuration 900 may communicate via network 914, which may be the internet, for playing the video game over the internet amongst various other connected players.

Each of the processors (e.g., 904) described herein may be configured to execute instructions that may be stored in the corresponding memories (e.g., 906). The processors may include one or more processing units (e.g., in a multi-core configuration) for executing instructions, and may be configured to operate in a parallel processing environment as described herein. The instructions may be executed within a variety of different operating systems on the respective systems, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.). Memories 906 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program. Memories 906 may further include one or more computer-readable media, such as one or more hard disk drives or solid state disks in a redundant array of inexpensive disks (RAID) configuration, and further may include a storage area network (SAN) and/or a network attached storage (NAS) system. Storage interfaces of memories 906 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processors with access to the storage devices. Each of the various communication interfaces (e.g., 912) described herein may be communicatively couplable to a remote device such as a server system (not shown) or a web server, such as in connection with network 914, and may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

The term “processor”, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

This disclosure uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A trivia game for one or more players comprising:
a plurality of trivia cards, each trivia card of the plurality of trivia cards including thereon (i) text representing a plurality of card trivia question categories, and (ii) text representing a plurality of contextually-linked trivia questions relating to the plurality of card trivia question categories, the plurality of contextually-linked trivia questions including:
a set of first questions including a first chance of answering any given first question of the set of first questions correctly; and
a set of second questions including a second chance of answering any given second question of the set of second questions correctly, and the any given second question being contextually-linked to the any given first question; and
a die including a plurality of sides, at least one side of the plurality of sides including thereon text representing a die trivia question category that corresponds to at least one card trivia question category of the plurality of card trivia question categories,
wherein a turn of the trivia game includes:
a player rolling the die to land the die trivia question category;
one trivia card of the plurality of trivia cards being drawn for the player;
an associated first question of the set of first questions of the one trivia card that has a card trivia question category that corresponds with the landed die trivia question category is presented to the player for answering;
if the associated first question is answered correctly by the player, an associated second question of the set of second questions of the one trivia card is presented to the player for answering, the associated second question including subject matter that is contextually related to subject matter of the associated first question; and
if the associated second question is answered correctly by the player, the player is awarded with a total amount of points corresponding to the correctly answered associated first question and the correctly answered associated second question.

2. The trivia game of claim 1, wherein text representing each die trivia question category on the die matches text representing each card trivia question category of the plurality of card trivia question categories for each die trivia question category and card trivia question category that are the same.

3. The trivia game of claim 1, wherein the first chance is a fifty percent chance.

4. The trivia game of claim 1, wherein the plurality of sides is eight sides.

5. The trivia game of claim 1, wherein each trivia card of the plurality of trivia cards includes a first side and a second side opposite the first side.

6. The trivia game of claim 5, wherein the set of first questions is presented on the first side, and the set of second questions is presented on the second side.

7. The trivia game of claim 6, wherein a bonus indicator symbol is provided on the second side in association with at least one second question of the set of second questions.

8. The trivia game of claim 6, wherein the set of first questions includes five first questions and the set of second questions includes five second questions.

9. The trivia game of claim 8, wherein each first question of the five first questions is directed to a different card trivia question category of the plurality of card trivia question categories.

10. The trivia game of claim 9, wherein each second question of the five second questions is directed to a same card trivia question category as a corresponding respective first question of the five first questions.

11. A method of playing a trivia game for one or more players comprising:
providing a plurality of trivia cards, each trivia card of the plurality of trivia cards including thereon (i) text representing a plurality of card trivia question categories, and (ii) text representing a plurality of contextually-linked trivia questions relating to the plurality of card trivia question categories, the plurality of contextually-linked trivia questions including:
a set of first questions including a first chance of answering any given first question of the set of first questions correctly; and
a set of second questions including a second chance of answering any given second question of the set of second questions correctly, and the any given second question being contextually-linked to the any given first question;
providing a die including a plurality of sides, at least one side of the plurality of sides including thereon text of a die trivia question category that corresponds to at least one card trivia question category of the plurality of card trivia question categories; and
playing a turn of the trivia game, the playing comprising:
rolling, by a player, the die to land the die trivia question category;
drawing one trivia card of the plurality of trivia cards for the player;
presenting an associated first question of the set of first questions of the one trivia card that has a card trivia question category that corresponds with the landed die trivia question category to the player for answering;
if the associated first question is answered correctly by the player, presenting an associated second question of the set of second questions of the one trivia card to the player for answering, the associated second question including subject matter that is contextually related to subject matter of the associated first question; and
if the associated second question is answered correctly by the player, awarding the player with a total amount of points corresponding to the correctly answered associated first question and the correctly answered associated second question.

12. The method of claim 11, wherein text representing each die trivia question category on the die matches text representing each card trivia question category of the plurality of card trivia question categories for each die trivia question category and card trivia question category that are the same.

13. The method of claim 11, wherein the first chance is a fifty percent chance.

14. The method of claim 11, wherein the plurality of sides is eight sides.

15. The method of claim 11, wherein each trivia card of the plurality of trivia cards includes a first side and a second side opposite the first side.

16. The method of claim 15, wherein the set of first questions is presented on the first side, and the set of second questions is presented on the second side.

17. The method of claim 16, wherein a bonus indicator symbol is provided on the second side in association with at least one second question of the set of second questions.

18. The method of claim 16, wherein the set of first questions includes five first questions and the set of second questions includes five second questions.

19. The method of claim 18, wherein each first question of the five first questions is directed to a different card trivia question category of the plurality of card trivia question categories.

20. The method of claim 19, wherein each second question of the five second questions is directed to a same card trivia question category as a corresponding respective first question of the five first questions.
